(19) United States
(12) Patent Application Publication
(10) Pub. No.: US 2009/0100101 A1
(43) Pub. Date: Apr. 16, 2009

(54) Method and System for Gathering, Analyzing and Disseminating Mind-Based Perceptions

(76) Inventor: Diane Marotta, Norristown, PA (US)

Correspondence Address: Saul Ewing LLP (Philadelphia), Attn: Patent Docket Clerk, 2 North Second St., Harrisburg, PA, 17101, US

(21) Appl. No.: 12/243,953

(22) Filed: Oct. 1, 2008

Related U.S. Application Data
(60) Provisional application No. 60/976,551, filed on Oct. 1, 2007.

(51) Int. Cl. G06F 17/30

(52) U.S. Cl. 707/104.1; 707/E17.009

(57) ABSTRACT

Data pertaining to mind-based perceptions is gathered from numerous sources via computer and, using statistical techniques, mind-based perceptions that are commonly occurring are identified. By considering mind-based perceptions from multiple sources that are repeated with a frequency above a certain threshold level, investigators can focus on events that are commonly-appearing at any given time, thereby filtering out much of the “noise” that could be associated with one-time or reoccurring-but-not-specific.

### CROSS-REFERENCE TO RELATED APPLICATIONS

This application is based on and claims priority to U.S. Provisional Application No. 60/976,551, filed Oct. 1, 2007, the entire contents of which are hereby incorporated by reference.

### BACKGROUND OF THE INVENTION

1. Field of the Invention

This invention relates to a method and system for gathering, analyzing, interpreting, and disseminating information pertaining to extra-sensory and/or prescient information, and more particularly, to the use of the potentially predictive value of such information to identify imminent, specific and/or serious threats to the public or individuals.

2. Description of the Related Art

Extra-sensory perception (ESP), premonitions, “feelings” and the like, referred to herein as “mind-based perceptions”, have been known for many years. While many in the scientific community remain skeptical about the veracity of information from these psychic sources, the validity of such information cannot be expressly repudiated either. Numerous examples exist in history of people who have claimed to have premonitions of major catastrophic events, such as the sinking of the Titanic, the assassination of President Lincoln, the attack on the World Trade Center Towers and Pentagon, and the like.

The use of psychics in criminal investigations has been well documented. In Psychic Criminology: A Guide for Using Psychics in Investigations (Hibbard, W. S., Worring, R. W., and Brennen, R.; Charles C. Thomas Publications Limited, 2002) the authors provide a comprehensive manual of operations for using psychics in criminal investigations, and provide first-person accounts from law enforcement personnel who have used psychics in criminal investigations. Despite entrenched skepticism regarding the validity of psychic predictions, the wealth of substantiated claims has prompted law enforcement officials to actively recruit such individuals claiming to be prescient.

### SUMMARY OF THE INVENTION

In accordance with the present invention, data pertaining to mind-based perceptions is gathered from numerous sources via computer and, using statistical techniques, mind-based perceptions that are commonly occurring are identified. By considering mind-based perceptions from multiple sources that are repeated with a frequency above a certain threshold level, investigators can focus on events that are commonly-appearing at any given time, thereby filtering out much of the “noise” that could be associated with one-time or reoccurring-but-not-specific premonitions (e.g., someone who states they have a feeling that the President will be shot, but gives no information regarding date, time, location, etc.).

This information is gathered from as many sources as possible, and then standard data processing techniques are used to statistically categorize and analyze the received data. Categories can be established for various types of events. Such events can be characterized based upon time, place and nature of incident. In a preferred embodiment, participants can select the appropriate parameters from a drop-down menu on a website specifically set up and managed for use in connection with the present invention. Individuals may also record additional information in a response box on the same website in this embodiment. The information in the response box can be compared against the individual's drop-down menu selections to monitor the correlation between the two data input approaches. Consequently, such feedback will enable any necessary modifications to the drop-down menu selections. If desired, crime analysts trained to detect patterns in crime may be recruited to assist in determining where in the database particular events should be classified and/or whether or not they should be put in the database at all.

### BRIEF DESCRIPTION OF THE DRAWINGS

FIG. 1 is a flowchart illustrating the basic steps performed in accordance with the present invention;

FIG. 2 illustrates a representative workstation hardware environment in which the present invention may be practiced; and

FIG. 3 illustrates a data processing network in which the present invention may be practiced.

### DETAILED DESCRIPTION OF THE PREFERRED EMBODIMENTS

The present invention, rather than attempting to prove or disprove the veracity of information gathered from psychic sources, instead gathers as much data pertaining to mind-based perceptions as possible from numerous sources and, using statistical techniques, identifies mind-based perceptions that are commonly occurring. In a preferred embodiment, the present invention is computer-implemented. By looking at mind-based perceptions from multiple sources that are repeated with a frequency above a certain threshold level, investigators can focus on events that are commonly-appearing at any given time, thereby filtering out much of the “noise” that could be associated with one-time or reoccurring-but-not-specific premonitions (e.g., someone who states they have a feeling that the President will be shot, but gives no information regarding date, time, location, etc.).

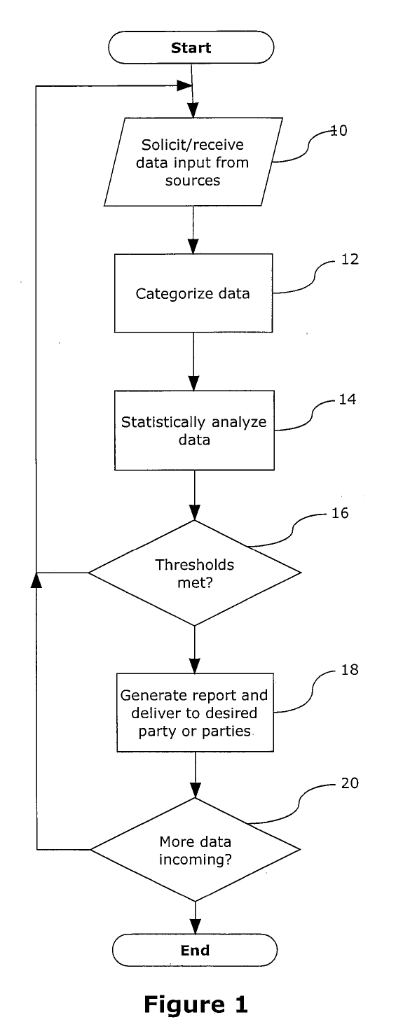

FIG. 1 is a flowchart illustrating basic steps performed in accordance with the present invention. In the preferred embodiment, these steps are computer-implemented, that is, one or more computers are utilized to obtain the input data, categorize it, analyze it, determine if thresholds have been met, and generate and communicate reports to the appropriate recipients. Obviously human interaction with the computer(s) will be needed, at some level, to configure the computer(s) to function accordingly, as is well known. The steps are described generally below with respect to FIG. 1, and then additional details are provided following the description of FIG. 1.

Referring to FIG. 1, the process begins and at step 10, data is solicited and/or received from sources of mind-based perceptions, including “known” psychics. In a preferred embodiment, it is contemplated that such information will be gathered using input to a website set up for this purpose. Information can be solicited or received from any source, however, it is contemplated that if information is to be received from anonymous or unknown sources, such information would be identified as such and could be weighted less than information received from known sources. If desired, controls on who can and cannot input data to the system of the present invention can be put in place, such as requiring registration with the service, password protected access, and the like. The information received is stored in a known manner, for example, in computer memory.

At step 12, the received data is categorized. Numerous categories can be established, and more detailed information regarding various categorization techniques is given below. At step 14, the categorized data is statistically analyzed, and at step 16, a determination is made to see if predetermined thresholds relating to the data have been met (e.g., are there more than X number of premonitions of a specific event being received, are there more than Y number of premonitions of a more general event, but at the same location and time, being received, etc.?). If the threshold has not been met, then the process proceeds back to step 10 where receipt of data continues.

If at step 16, a threshold has been met, the process proceeds to step 18, and a report appropriate for the met threshold is generated and automatically reported to an appropriate participant, e.g., one or more agencies with interest in the predicted event. At step 20 a determination is made as to whether or not there is additional data incoming. If there is, the process reverts back to step 10 and the monitoring continues. If there is no more data incoming, the process ends.

This information is gathered from as many sources as possible, and then standard data processing techniques are used to statistically categorize and analyze the received data. Categories can be established for various types of events. Such events can be characterized based upon time, place and nature of incident. In a preferred embodiment, participants can select the appropriate parameters from a drop-down menu on a website specifically set up and managed for use in connection with the present invention. Individuals may also record additional information in a response box on the same website in this embodiment. The information in the response box can be compared against the individual's drop-down menu selections to monitor the correlation between the two data input approaches. Consequently, such feedback will enable any necessary modifications to the drop-down menu selections. If desired, crime analysts trained to detect patterns in crime may be recruited to assist in determining where in the database particular events should be classified and/or whether or not they should be put in the database at all.

At any desired interval (daily, hourly, weekly, each minute, etc.) the data can be statistically analyzed to look for reoccurring psychic information. If the data analyzed and interpreted indicates a significant recurrence of a particular event above a predetermined threshold level, measures can be taken to inform law enforcement agencies or other interested organizations, and, if appropriate, the public at large. Specifically, once a critical threshold is reached, reports may automatically be generated and sent to the appropriate agencies. If desired, the reports may also be sent to a system administrator, the inventor or other monitoring parties, so that the success rate of the project may be regularly gauged. As an example, the Federal Emergency Management Agency (FEMA) branch in Philadelphia, Pa. has indicated a willingness to provide a contact to which reports may be emailed. Depending on the nature of the threat, divisions within FEMA involved with chemical spills, terrorism, etc., may be alerted.

Some information received may be weather-related. The National Oceanic and Atmospheric Administration's National Weather Service could accept reports and disseminate them to the appropriate local weather stations if they are deemed relevant. The Department of Agriculture can provide a contact for reports which detail agricultural and environmental considerations. Finally, other agencies including the Federal Bureau of Investigation and the World Meteorological Organization may be interested in receiving information.

Standard data gathering, classification, and processing techniques are utilized in connection with the present invention. The invention resides not so much in the techniques used for gathering, storing and analyzing the data, rather, the invention resides primarily in a method whereby information from numerous and diverse psychic sources is funneled to a single location and entered into a database, processed, analyzed, and if the results indicate, disseminated appropriately.

Information regarding occurrences of mind-based perceptions can be input via a web-based system whereby a person having a premonition can log on, select specific parameters including time, location and nature of event and post a detailed account of an impression. For example, as part of the entry process, the person can be asked if the entry relates to a crime, a natural disaster, etc. Event types which may be selected include, but are not limited to, natural disasters such as floods and earthquakes and human disasters including environmental accidents, technological accidents, crime and terrorism. For purposes of brevity, subcategories have not been enumerated herein, but participants may select the category or subdivision with which they are most confident. Similarly, time and place can be subdivided accordingly, and participants may choose the specific parameter based upon their level of certainty. For example, under a current prototype under test, participants may select among 275 countries, 3,958 regions/states and 36,642 cities.

The participants can also be prompted to provide a narrative of the premonition which can be read by analysts regarding the substance of the premonition, as well as by administrators of the system to assist in categorizing the information. Any information which will provide pertinent information to an investigator, analyst, or both, can be solicited from the web-based system. To protect the integrity of the information being submitted, in a preferred embodiment, users will be required to register and log on before data can be input.

Alternatively, the information can be actively solicited from people who are known to have, or claim to have, psychic abilities, and the information taken down by the solicitor. That is, instead of the data arising from the impressions of the general public, select, reputedly intuitive individuals will exclusively input their premonitions. This provides more control over the source of the information, but limits the information received to certain known individuals, which may lead to less predictive capability. A third alternative can be to do both; provide an interactive input mechanism such as web-based system, and also actively solicit information from known entities. This might result in the most comprehensive and accurate information.

To promote the present invention and assist in monitoring its success, a website can be set up to serve as a news site in which stories broken using the methodology above will be reported. Monitoring the success rate of the project over weeks or months, for instance, and reporting it to the public, may provide invaluable insights which may serve as feedback to optimize the system.

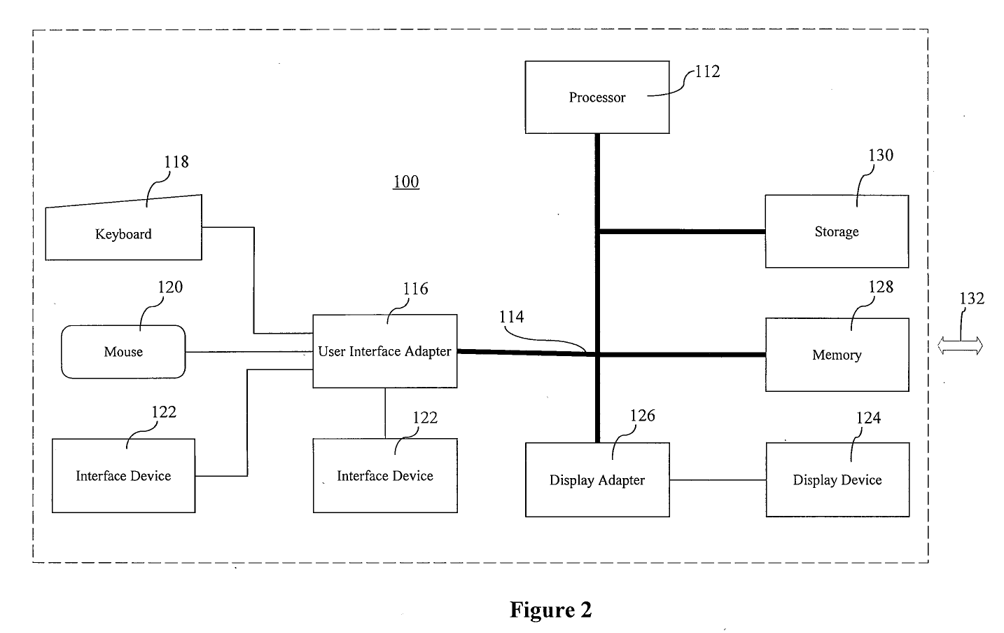

Following is a description of a typical processing environment which can be used to create and manage the hierarchical structures in accordance with the present invention. FIG. 2 illustrates a representative workstation hardware environment in which the present invention may be practiced. The environment of FIG. 2 comprises a representative single user computer workstation 100, such as a personal computer, including related peripheral devices. The workstation 100 includes a microprocessor 112 and a bus 114 employed to connect and enable communication between the microprocessor 112 and the components of the workstation 100 in accordance with known techniques. The workstation 100 typically includes a user interface adapter 116, which connects the microprocessor 112 via the bus 114 to one or more interface devices, such as keyboard 118, mouse 120, and/or other interface devices 122, which can be any user interface device, such as a touch sensitive screen, digitized entry pad, etc. The bus 114 also connects a display device 124, such as an LCD screen or monitor, to the microprocessor 112 via a display adapter 126. The bus 114 also connects the microprocessor 112 to memory 128 and long term storage 130 which can include a hard drive, tape drive, etc.

The workstation 100 communicates via a communications channel 132 with other computers or networks of computers. The workstation 100 may be associated with such other computers in a local area network (LAN) or a wide area network, or the workstation 100 can be client in a client/server arrangement with another computer, etc. All of these configurations, as well as the appropriate communications hardware and software, are known in the art.

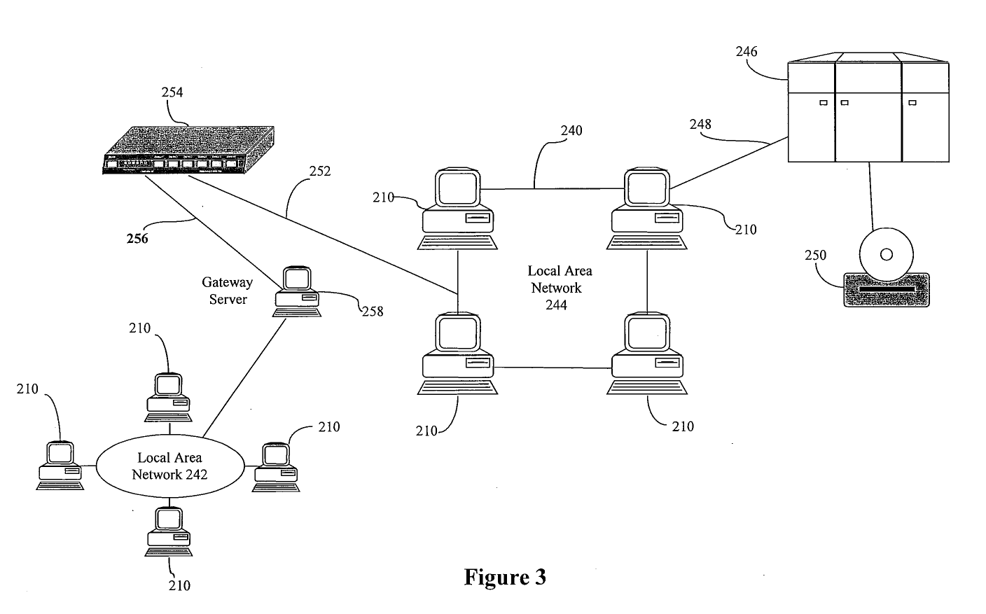

FIG. 3 illustrates a data processing network 240 in which the present invention may be practiced. The data processing network 240 includes a plurality of individual networks, including LANs 242 and 244, each of which includes a plurality of individual workstations 100. Alternatively, as those skilled in the art will appreciate, a LAN may comprise a plurality of intelligent workstations coupled to a host processor.

Still referring to FIG. 3, the data processing network 240 may also include multiple mainframe computers, such as a mainframe computer 246, which may be preferably coupled to the LAN 244 by means of a communications link 248.

The mainframe computer 246 may also be coupled to a storage device 250, which may serve as remote storage for the LAN 244. Similarly, the LAN 244 may be coupled to a communications link 252 through a router 254 and a communications link 256 to a gateway server 258. The gateway server 258 is preferably an individual computer or intelligent workstation which serves to link the LAN 242 to the LAN 244.

Those skilled in the art will appreciate that the mainframe computer 246 may be located a great geographic distance from the LAN 244, and similarly, the LAN 244 may be located a substantial distance from the LAN 242. For example, the LAN 242 may be located in California, while the LAN 244 may be located in Texas, and the mainframe computer 246 may be located in New York.

The above-described steps can be implemented using standard well-known programming techniques. The novelty of the above-described embodiment lies not in the specific programming techniques but in the use of the steps described to achieve the delineated results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-3 support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

Although the present invention has been described with respect to a specific preferred embodiment thereof, various changes and modifications may be suggested to one skilled in the art and it is intended that the present invention encompasses such changes and modifications as fall within the scope of the appended claims.

I claim:

1. A computer-implemented method for identifying trends in mind-based perceptions, comprising:
obtaining and storing, in a computer, data pertaining to mind-based perceptions from multiple sources;
categorizing said stored data, using said computer, based on predetermined categorization parameters;
statistically analyzing said categorized data, using said computer, to identify recurring mind-based perceptions; and
generating an event report, using said computer, when the recurrence of a mind-based perception reaches a predetermined threshold.

2. The method of claim 1, further comprising:
automatically forwarding said event report, using said computer, to one or more entities having an interest in the content of said event report.

3. The method of claim 2, wherein said predetermined categorization categories include a location where an incident is perceived to be occurring in the future.

4. The method of claim 3, wherein said predetermined categorization categories further include a time and date that an incident is perceived to be occurring in the future.

5. The method of claim 4, wherein said predetermined categorization categories include a nature of an incident that is perceived to be occurring in the future.

6. The method of claim 1, wherein said obtaining and storing step comprises providing a website on which individuals are provided with a menu-driven template that enables the individuals to input information regarding mind-based perceptions in a consistent format.

7. The method of claim 1, wherein said statistical analysis step is performed at predetermined intervals.

8. A computer-implemented system for identifying trends in mind-based perceptions, comprising:
means for obtaining and storing, in a computer, data pertaining to mind-based perceptions from multiple sources;
means for categorizing said stored data, using said computer, based on predetermined categorization parameters;
means for statistically analyzing said categorized data, using said computer, to identify recurring mind-based perceptions; and
means for generating an event report, using said computer, when the recurrence of a mind-based perception reaches a predetermined threshold.

9. The system of claim 8, further comprising:
means for automatically forwarding said event report, using said computer, to one or more entities having an interest in the content of said event report.

10. The system of claim 9, wherein said predetermined categorization categories include a location where an incident is perceived to be occurring in the future.

11. The system of claim 10, wherein said predetermined categorization categories further include a time and date that an incident is perceived to be occurring in the future.

12. The system of claim 11, wherein said predetermined categorization categories include a nature of an incident that is perceived to be occurring in the future.

13. The system of claim 8, wherein said obtaining and storing step comprises providing a website on which individuals are provided with a menu-driven template that enables the individuals to input information regarding mind-based perceptions in a consistent format.

14. The system of claim 8, wherein said statistical analysis step is performed at predetermined intervals.
